(19) United States
(12) Patent Application Publication
(10) Pub. No.: US 2022/0131329 A1
(43) Pub. Date: Apr. 28, 2022

(54) MULTI-WAVELENGTH AND SINGLE-FREQUENCY Q-SWITCHING OPTICAL FIBER LASER DEVICE

(71) Applicant: SOUTH CHINA UNIVERSITY OF TECHNOLOGY, Guangzhou (CN)

(72) Inventors: Shanhui XU, Guangzhou (CN); Kunyi LI, Guangzhou (CN); Changsheng YANG, Guangzhou (CN); Qilai ZHAO, Guangzhou (CN); Zhouming FENG, Guangzhou (CN); Zhongmin YANG, Guangzhou (CN)

(73) Assignee: SOUTH CHINA UNIVERSITY OF TECHNOLOGY, Guangzhou (CN)

(21) Appl. No.: 17/427,106

(22) PCT Filed: Oct. 28, 2019
(86) PCT No.: PCT/CN2019/113798

§ 371 Date: Jul. 30, 2021

(30) Foreign Application Priority Data
Jan. 31, 2019 (CN) 201910100651.0

(51) Int. Cl. H01S 3/067; H01S 3/11; H01S 3/04; H01S 3/10

(52) U.S. Cl. CPC H01S 3/06712; H01S 3/1115; H01S 3/10061; H01S 3/0675; H01S 3/0405

(57) ABSTRACT

The invention discloses a multi-wavelength and single-frequency Q-switching optical fiber laser device. The laser device comprises a saturable absorber, a high gain optical fiber, a polarization-maintaining multi-wavelength narrow-band fiber Bragg grating, a resonant cavity temperature control module, a polarization-maintaining wavelength division multiplexer, a pump source and a polarization-maintaining light isolator. By taking a highly doped phosphate optical fiber as a laser gain medium, two ends of the optical fiber device are connected with the saturable absorber and the polarization-maintaining multi-wavelength narrow-band fiber Bragg grating respectively to form a short linear laser cavity. A short cavity length of the short linear laser cavity can realize single longitudinal mode operation of laser in the resonant cavity, and meanwhile, a stable multi-wavelength and single-frequency pulse laser output is realized in the resonant cavity by combining multi-wavelength resonance caused by the polarization-maintaining multi-wavelength narrow-band fiber Bragg grating with passive Q-switching performance of the saturable absorber in the cavity. The multi-wavelength single-frequency Q-switching optical fiber laser device of the invention realizes output of a plurality of wavelength pulse laser with adjusted repeated frequency simultaneously, and the laser in each wavelength is maintained in single-frequency operation, such that the multi-wavelength single-frequency Q-switching optical fiber laser device can be widely applied to aspects of laser radar, laser sensing, gas detection and the like.

### TECHNICAL FIELD

The present invention belongs to the technical field of optical fiber laser devices and relates to a multi-wavelength and single-frequency Q-switching optical fiber laser device.

### BACKGROUND

As the Q-switching pulse optical fiber laser device featuring in being tunable, simple in structure, convenient to integrate and the like, it therefore has an important application prospect in aspects of laser radar, laser sensing, gas detection and the like. In particular, the multi-wavelength and single-frequency Q-switching optical fiber laser device generates comb pulse laser with different wavelengths simultaneously in the laser resonant cavity based on a common Q-switching pulse optical fiber laser device and guarantee that the laser wavelength each operates at the single frequency, thereby improving the detection precision of the pulse laser device as a detecting light source effectively and widening the detection type range of laser radar greatly. The multi-wavelength and single-frequency Q-switching optical fiber laser device applied to differential absorbing gas analytical laser radar can increase the types of gases detected by a single time, thereby improving the detection efficiency.

For the optical fiber laser device, an optical fiber ring or a multi-wavelength optical fiber Bragg grating can be inserted into the resonant cavity to lead to multi-wavelength laser oscillation. On the other hand, the saturable absorber can be inserted to lead to passive Q switching in the resonant cavity to achieve pulse laser. The absorption coefficient of the saturable absorber will change along with light intensity, such that the adsorption loss in the resonant cavity is changed, thereby playing a role of a Q-switch. Compared with other pulse modulation components, the saturable absorber is high in reflectivity, compact in structure and easy to integrate and can form front and back endoscopes of the resonant cavity with the multi-wavelength optical Bragg grating, thereby shortening the cavity length of the resonant cavity favorably. The cavity length is shortened, such that adjacent laser longitudinal modes in the resonant cavity are spaced wider. When the reflective bandwidth of each reflective region of the polarization-maintaining multi-wavelength narrow-band optical Brag grating is narrowed to a certain extent, it can ensure that only one laser longitudinal mode at each wavelength reaches a gain threshold value, such that the laser device is maintained operation at the single longitudinal mode. In addition, under a room temperature condition, as rare earth ions will cause homogeneous broadening of gain, mode competition among the wavelengths results in hardly stable output of multi-wavelength pulse laser. Therefore, it needs to control the temperature of the resonant cavity. By adjusting the temperature of the resonant cavity, gains of signal lights at different wavelengths can be adjusted, such that the gain of the signal light at each wavelength is greater than its loss, and thus, the laser wavelength is controlled. On the other hand, a light path adopting a polarization-maintaining structure can enable laser with different wavelengths to work in different polarization states, thereby reducing the gain competition. The multi-wavelength and single-frequency Q-switching optical fiber laser device based on polarization-maintaining short straight cavity structure has wide application prospects because of its narrow line width, compact structure and stable output.

There are related patents: (1) In 2014, Shanghai Institute of Optical and Fine Mechanics of Chinese Academy of Sciences has applied a patent [CN 103779776A]: seed injection single-frequency pulse laser based on an electro-optical crystal turning cavity length. By means of an electro-optical effect of electro-optical crystal, the refractive index of the electro-optical crystal and the optical cavity length of the system are changed as a driving power supply voltage is changed to form the Q-switch, thereby realizing single-frequency Q-switching pulse laser output. But the patent is not all fiber at all, is complex in structure and only can realize single-frequency operation of single wavelength without realizing output of multi-wavelength laser simultaneously. (2) In 2014, Shandong University of Technology has applied a patent [publication No. CN 104377541A] of multi-wavelength turnable Q-switching optical fiber laser device, Q-switching is induced by covering a surface of a tapered optical fiber with graphene, and a light field generates a phase difference in the tapered optical fiber to form interference to form the multi-wavelength laser, such that output of multi-wavelength turnable Q-switching laser is realized. (3) in 2016, Academy of Military Medical Sciences of PLA has applied a patent [publication No. CN 205693132U] of dual channel multi-wavelength pulse laser. Dual channel pulse laser is coupled to an output light path by means of a spatial light path and a frequency doubling mirror, such that output of dual channel multi-wavelength pulse laser is realized. However, the Q-switching pulse laser required by the patents (2) and (3) at each output wavelength has not yet realized operation at the single longitudinal mode (single frequency).

### SUMMARY

It is thereof an object of the present invention to provide a multi-wavelength and single-frequency Q-switching optical fiber laser device. By means of the Q-switching characteristic of the saturable absorber, the saturable absorber and the polarization-maintaining multi-wavelength narrow-band optical Bragg grating are abutted to two ends of the centimeter-level high gain optical fiber by combining the polarization-maintaining multi-wavelength narrow-band optical Bragg grating to select the wavelength of the signal light so as to form the laser resonant cavity of a distributed Bragg short linear cavity structure. By carrying out precise temperature control on the resonant cavity by a temperature control module, under a pump action of the pump source, the multi-wavelength single-frequency Q-switching optical fiber laser with high performance can be directly output from the resonant cavity.

In order to achieve the object, the present invention adopts technical solutions as follows.

A multi-wavelength and single-frequency Q-switching optical fiber laser device includes a Bragg laser resonant cavity, a cavity temperature control module, a high gain optical fiber, a polarization-maintaining wavelength division multiplexer (Wavelength Division Multiplexer, WDM), a pump source (Laser Diode, LD) and a polarization-maintaining light isolator (Isolator, ISO). The Bragg laser resonant cavity includes the high gain optical fiber, a saturable absorber and a polarization-maintaining multi-wavelength narrow-band fiber Bragg grating, two ends of the high gain optical fiber are connected with the saturable absorber and the polarization-maintaining multi-wavelength narrow-band fiber Bragg grating respectively, and the Bragg laser resonant cavity is placed in the cavity temperature control module to carry out temperature control; a pump end of the polarization-maintaining wavelength division multiplexer is connected with the pump source, a common end of the polarization-maintaining wavelength division multiplexer is connected with the polarization-maintaining multi-wavelength narrow-band fiber Bragg grating, and a signal end of the polarization-maintaining wavelength division multiplexer is connected with an input end of the polarization-maintaining light isolator. Pump light generated by the pump source is input via the pump end of the polarization-maintaining wavelength division multiplexer, is then coupled to the high gain optical fiber to be pumped via the polarization-maintaining multi-wavelength narrow-band optical Bragg grating to generate multi-wavelength single-frequency pulse laser in the Bragg laser resonant cavity, a pump end of the polarization-maintaining wavelength division multiplexer is connected with the pump source, a common end of the polarization-maintaining wavelength division multiplexer is connected with the polarization-maintaining multi-wavelength narrow-band fiber Bragg grating, and a signal end of the polarization-maintaining wavelength division multiplexer is connected with an input end of the polarization-maintaining light isolator. A pump light generated by the pump source is input by the pump end of the polarization-maintaining wavelength division multiplexer, and then coupled to the high gain optical fiber through the polarization-maintaining multi-wavelength narrow-band fiber Bragg grating for pumping. A multi wavelength single frequency pulse laser is generated in the Bragg laser resonant cavity. The signal end of the polarization-maintaining wavelength division multiplexer is connected with the input end of the polarization-maintaining light isolator. Finally, the multi-wavelength and single-frequency Q-switching optical fiber laser generated by the Bragg laser resonant cavity is output through an output end of the polarization-maintaining light isolator.

Further preferably, a relaxation time of the saturable absorber is shorter than 20 ps, a reflectivity of the saturable absorber to a laser signal light with each wavelength is greater than 80%, and a saturable absorber thereof to a pump light is smaller than 20%.

Further preferably, the high gain optical fiber is a rare earth doped single mode glass optical fiber, and a fiber core component of the high gain optical fiber includes more than one of phosphate glass, germanate glass, silicate glass and fluoride glass; the fiber core of the high gain optical fiber is doped with luminous ions in high concentration, and the luminous ions are a complex of one or more of lanthanide ions and transition metal ions; and a doping concentration of the luminous ions is greater than 1*1019 ions/cm3 and the luminous ions are uniformly doped in the fiber core of the high gain optical fiber.

Further preferably, the polarization-maintaining multi-wavelength narrow-band fiber Bragg grating is structured such that two or more Bragg gratings with different center wavelengths are written onto a polarization-maintaining optical fiber, such that the polarization-maintaining multi-wavelength narrow-band fiber Bragg grating has selective comb reflection on a laser signal wavelength.

Further preferably, a 3 dB reflective bandwidth of each of reflective sections of the polarization-maintaining multi-wavelength narrow-band fiber Bragg grating is not greater than 0.08 nm, and a reflectivity of the polarization-maintaining multi-wavelength narrow-band fiber Bragg grating to the laser signal light wavelength is greater than 50%.

Further preferably, the polarization-maintaining multi-wavelength narrow-band fiber Bragg grating and the high gain optical fiber are directly butt-coupled by grinding and polishing optical fiber end surfaces thereof respectively or are weld-coupled by means of an optical fiber fusion splicer.

Further preferably, the resonant cavity temperature control module includes a semiconductor refrigerator (Thermoelectric Cooler, TEC) and a control precision of the cavity temperature control module (2) is +/−0.01° C.

Compared with the prior art, the present invention has the technical effects that by means of the Q-switching characteristic of the saturable absorber, the saturable absorber and the polarization-maintaining multi-wavelength narrow-band optical Bragg grating are abutted to two ends of the centimeter-level high gain optical fiber by combining the polarization-maintaining multi-wavelength narrow-band optical Bragg grating to select the wavelength of the signal light so as to form the laser resonant cavity of a distributed Bragg short linear cavity structure; under continuous excitation of the laser pump source, the working temperature of the resonant cavity is controlled precisely by means of the resonant cavity temperature control module, such that Q-switching and multi-wavelength hotshot of laser are realized simultaneously in the short linear cavity. In addition, as the cavity length of the resonant cavity is shorter and the reflective bandwidth at each wavelength of the narrow-band optical Bragg grating is narrower, such that it is ensured that each wavelength laser operates at the single frequency, and thus, output of multi-wavelength and single-frequency Q-switching pulse laser with stable performance can be obtained. The multi-wavelength and single-frequency Q-switching optical fiber laser device obtained by the present invention can be full optical fiber, is compact in structure, stable in working performance, easy to maintain and low in cost and is an ideal light source of systems such as laser radar, laser remote sensing and gas detection.

### BRIEF DESCRIPTION OF THE DRAWINGS

FIG. 1 is a structural schematic diagram of the multi-wavelength and single-frequency Q-switching optical fiber laser device provided by the present invention.

In the drawings, 1—saturable absorber, 2—resonant cavity temperature control module, 3—high gain optical fiber, 4—polarization-maintaining multi-wavelength narrow-band fiber Bragg grating, 5—polarization-maintaining wavelength division multiplexer, 6—pump source, 7—polarization-maintaining light isolator.

### DETAILED DESCRIPTION

Further detailed description will be made on the present invention below by specific embodiments, and it should be noted that the claimed scope of protection of the present invention is not limited to the scope represented by the embodiments.

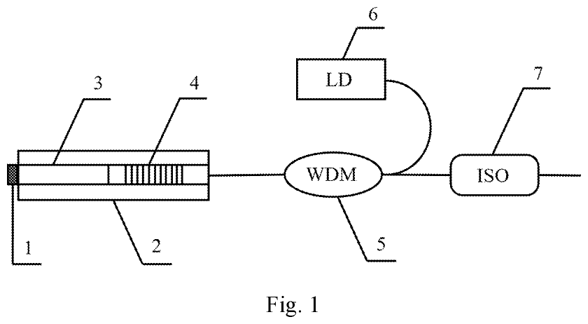

As shown in the FIG. 1, the multi-wavelength and single-frequency Q-switching optical fiber laser device includes the saturable absorber 1, the high gain optical fiber 3, the polarization-maintaining multi-wavelength narrow-band fiber Bragg grating 4, the resonant cavity temperature control module, the pump source 6, the polarization-maintaining wavelength division multiplexer 5, and the polarization-maintaining light isolator 7. A structural relationship among the parts is as follows: one end of the high gain optical fiber 3 is connected with the saturable absorber 1 and the other end of the high gain optical fiber 3 is connected with one end of the polarization-maintaining multi-wavelength narrow-band fiber Bragg grating 4, the saturable absorber, the high gain optical fiber and the polarization-maintaining multi-wavelength narrow-band fiber Bragg grating are connected to form the distributed Bragg single-frequency laser resonant short cavity, i.e., the Bragg laser resonant cavity, and the Bragg laser resonant cavity is placed in the resonant cavity temperature control module 2 for precise temperature control. The pump end of the polarization-maintaining wavelength division multiplexer 5 is connected with a tail fiber of the pump source 6, the common end of the polarization-maintaining wavelength division multiplexer 5 is connected with the other end of the polarization-maintaining multi-wavelength narrow-band fiber Bragg grating 4, and the signal end of the polarization-maintaining wavelength division multiplexer 5 is connected with the input end of the polarization-maintaining light isolator 7. The multi-wavelength and single-frequency Q-switching optical fiber laser generated by the Bragg laser resonant cavity finally is output via the output end of the polarization-maintaining light isolator 7.

The laser working medium high gain optical fiber 3 used in the embodiment is a thulium-doped phosphate glass optical fiber. The doping concentration of thulium ions of the phosphate optical fiber in the fiber core is 4.5*10²⁰ ions/cm³ and a using length thereof is 2 cm. The saturable absorber 1 is a semiconductor saturable adsorbing mirror based on group III-V semiconductors, the reflective bandwidth is 1880-2040 nm, the reflectivity near 1950 nm is 90% and the relaxation time is 10 ps. The polarization-maintaining multi-wavelength narrow-band fiber Bragg grating 4 in the embodiment is structured such that two Bragg optical gratings are written into a same position of the polarization-maintaining optical fiber, such that a reflectance spectrum of the narrow-band optical Bragg grating has four reflecting peaks at a wavelength interval of 0.4 nm, wherein slow axis center wavelengths are respectively 1950.4 nm and 1951.2 nm and fast axis enter wavelengths are respectively 1950 nm and 1950.8 nm, the 3 dB reflective bandwidth of the reflective peak at each wavelength is 0.08 nm, and the reflectivity of the laser signal wavelength thereof is 65%. The saturable absorber 1 is abutted and coupled with the thulium-doped phosphate glass optical fiber on end surface, and the thulium-doped phosphate glass optical fiber and the polarization-maintaining multi-wavelength narrow-band fiber Bragg grating 4 are abutted and coupled via its end surface respectively, and the saturable absorber, the thulium-doped phosphate glass optical fiber and the polarization-maintaining multi-wavelength narrow-band fiber Bragg grating are combined to form the Bragg laser resonant cavity. The Bragg laser resonant cavity is placed in a metal copper tank, and the metal copper tank has a good wrapping property on the resonant cavity and can fix and protect the resonant cavity, and the resonant cavity control temperature module 2 formed by the TEC cooler controls the temperature of the whole Bragg laser resonant cavity precisely, and the control precision is +/−0.01° C. The pump source 6 with the working wavelength of 1610 nm is selected as well, and the pump output power thereof is 200 mW. The pump source 6 plays a role of pumping and transporting the Bragg laser resonant cavity via the 1610/1950 nm polarization-maintaining wavelength division multiplexer 5, and finally, the multi-wavelength and single-frequency Q-switching pulse laser output by the Bragg laser resonant cavity is output by the polarization-maintaining isolator 7 with a working center wavelength of 1950 nm. Based on the above mode, output of the Q-switching pulse optical fiber laser with multi-wavelengths (the working center wavelengths are respectively 1950, 1950.4, 1950.8 and 1951.2 nm) operating in the single longitudinal mode in each wavelength can be realized finally.

What is claimed is:

1. A multi-wavelength and single-frequency Q-switching optical fiber laser device, characterized in that, comprising: a Bragg laser resonant cavity, a cavity temperature control module (2), a high gain optical fiber (3), a polarization-maintaining wavelength division multiplexer (5), a pump source (6) and a polarization-maintaining light isolator (7), the Bragg laser resonant cavity comprises the high gain optical fiber (3), a saturable absorber (1) and a polarization-maintaining multi-wavelength narrow-band fiber Bragg grating (4), two ends of the high gain optical fiber (3) are connected with the saturable absorber (1) and the polarization-maintaining multi-wavelength narrow-band fiber Bragg grating (4) respectively, and the Bragg laser resonant cavity is placed in the cavity temperature control module (2) to carry out temperature control; a pump end of the polarization-maintaining wavelength division multiplexer (5) is connected with the pump source (6), a common end of the polarization-maintaining wavelength division multiplexer (5) is connected with the polarization-maintaining multi-wavelength narrow-band fiber Bragg grating (4), and a signal end of the polarization-maintaining wavelength division multiplexer (5) is connected with an input end of the polarization-maintaining light isolator (7).

2. The multi-wavelength and single-frequency Q-switching optical fiber laser device according to claim 1, characterized in that a relaxation time of the saturable absorber (1) is shorter than 20 ps, a reflectivity of the saturable absorber to a laser signal light with each wavelength is greater than 80%, and a saturable absorber thereof to a pump light is smaller than 20%.

3. The multi-wavelength and single-frequency Q-switching optical fiber laser device according to claim 1, characterized in that the high gain optical fiber (3) is a rare earth doped single mode glass optical fiber, and a fiber core component of the high gain optical fiber (3) comprises more than one of phosphate glass, germanate glass, silicate glass and fluoride glass; the fiber core of the high gain optical fiber (3) is doped with luminous ions in high concentration, and the luminous ions are a complex of one or more of lanthanide ions and transition metal ions; and a doping concentration of the luminous ions is greater than 1*1019 ions/cm3 and the luminous ions are uniformly doped in the fiber core of the high gain optical fiber (3).

4. The multi-wavelength and single-frequency Q-switching optical fiber laser device according to claim 1, characterized in that the polarization-maintaining multi-wavelength narrow-band fiber Bragg grating (4) is structured such that two or more Bragg gratings with different center wavelengths are written onto a polarization-maintaining optical fiber, such that the polarization-maintaining multi-wavelength narrow-band fiber Bragg grating has selective comb reflection on a laser signal wavelength.

5. The multi-wavelength and single-frequency Q-switching optical fiber laser device according to claim 1, characterized in that a 3 dB reflective bandwidth of each of reflective sections of the polarization-maintaining multi-wavelength narrow-band fiber Bragg grating (4) is not greater than 0.08 nm, and a reflectivity of the polarization-maintaining multi-wavelength narrow-band fiber Bragg grating to the laser signal light wavelength is greater than 50%.

6. The multi-wavelength and single-frequency Q-switching optical fiber laser device according to claim 1, characterized in that the polarization-maintaining multi-wavelength narrow-band fiber Bragg grating (4) and the high gain optical fiber (3) are directly butt-coupled by grinding and polishing optical fiber end surfaces thereof respectively or are weld-coupled by means of an optical fiber fusion splicer.

7. The multi-wavelength and single-frequency Q-switching optical fiber laser device according to claim 1, characterized in that the cavity temperature control module (2) comprises a semiconductor refrigerator (TEC) and a control precision of the cavity temperature control module (2) is +/−0.01° C.
